(19) United States
(12) Patent Application Publication
(10) Pub. No.: US 2010/0287015 A1
(43) Pub. Date: Nov. 11, 2010

(54) METHOD FOR DETERMINING THE COST OF EVALUATING CONDITIONS

(76) Inventors: Grace Au, Rancho Palos Verdes, CA (US); Conrad Tang, Torrance, CA (US)

Correspondence Address: JAMES M. STOVER;TERADATA CORPORATION, 2835 MIAMI VILLAGE DRIVE, MIAMISBURG, OH, 45342, US

(21) Appl. No.: 12/463,444

(22) Filed: May 11, 2009

(51) Int. Cl. G06Q 10/00; G06N 5/02; G06F 17/30

(52) U.S. Cl. 705/7; 706/52; 707/E17.017; 707/E17.044

(57) ABSTRACT

A method for determining the cost of evaluating queries against a database. The method includes receiving a condition, or query; determining the cost of one or more fixed cost operators within the condition; and determining the cost of one or more variable coefficients within the condition. The method may also be extended to determine the cost of successive conditions within a set of conditions as a function of the cost of a current condition and the combined selectivity of previous conditions within the set of conditions; and to determine an optimal order of conditions within a set of conditions. To determine an optimal order of conditions within a set of conditions, the method comprises determining the cost of one or more conditions within the set of conditions; determining the selectivity of one or more conditions within the set of conditions; and determining an optimal order of at least some of the conditions based at least partly on the determined cost and determined selectivity of one or more of the conditions.

### BACKGROUND

One of the fundamental decisions that a cost-based optimizer has to make is the optimal method to access the qualified rows in a relation/table given a set of selection conditions. This entails computing the cost of each applicable access method. The method with the lowest cost is picked. Typically the overall cost of an access method is the IO cost of accessing the data blocks in the table.

If an index is used, the cost of accessing the index structure is also included. Existing access method cost formulae do not include the CPU cost of evaluating selection conditions. Using such an existing method can result in loss of optimization opportunities. For example, consider the case where the IO cost of using a secondary index to access rows qualified by an IN predicate is slightly higher than the IO cost of full-table scan but the difference is much less than the CPU saving from not having to evaluate a long list of OR conditions on every row.

Different join methods also incur different cost of evaluating conditions. For example, spooling the qualified rows first before a merge join can consume more CPU for condition evaluation than doing the merge join directly which only incurs the cost of condition evaluation on rows that match on the rowhash.

It would be desirable to include the cost of condition evaluation in binary join costing. In this way the cost comparison of two competing join methods has the potential to be more accurate.

### SUMMARY

Described below are techniques for determining the cost of evaluating a condition. One aspect of the method comprises receiving a condition; determining the cost of one or more fixed cost operators within the condition; and determining the cost of one or more variable coefficients within the condition.

Also described below is a technique for determining the cost of evaluating a set of conditions. In one aspect the method comprises determining the cost of successive conditions within the set of conditions as a function of the cost of the current condition and the combined selectivity of previous conditions within the set of conditions.

Further described is a method of determining an optimal order of conditions within a set of conditions. The method comprises determining the cost of one or more conditions within the set of conditions; determining the selectivity of one or more conditions within the set of conditions; and determining an optimal order of at least some of the conditions based at least partly on the determined cost and determined selectivity of one or more of the conditions.

### BRIEF DESCRIPTION OF THE DRAWINGS

FIG. 1 is a block diagram of a computer system in which the techniques described below are implemented.

FIG. 2 is a block diagram of an exemplary large computer system in which the techniques described below are implemented.

### DETAILED DESCRIPTION

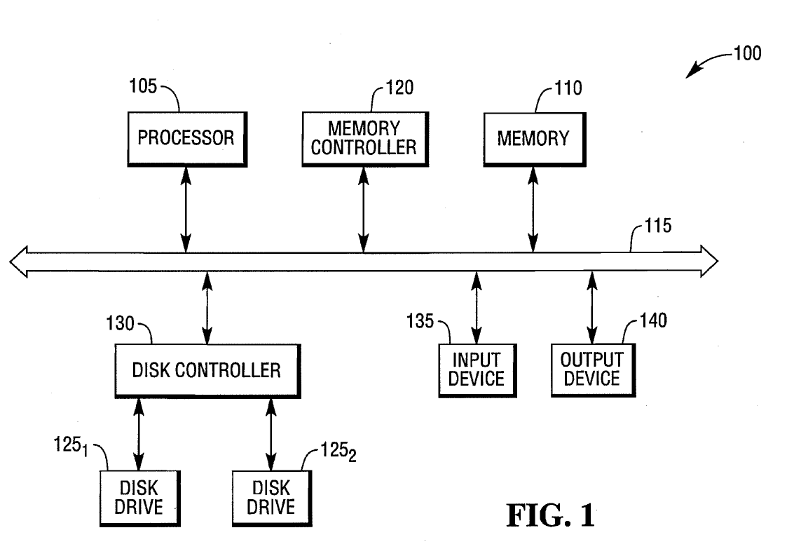

FIG. 1 shows a computer system 100 suitable for the evaluation of queries against stored data The system 100 includes one or more processors 105 that receive data and program instructions from a temporary data storage device, such as a memory device 110, over a communications bus 115. A memory controller 120 governs the flow of data into and out of the memory device 110. The system 100 also includes one or more persistent data storage devices, such as disk drives 125₁ and 125₂ that store chunks of data or data objects in a manner prescribed by one or more disk controllers 130. One or more input devices 135, such as a mouse and a keyboard, and output devices 140, such as a monitor and a printer, allow the computer system to interact with a human user and with other computers.

Computer system 100 is suitable for the execution of SQL statements and other database queries.

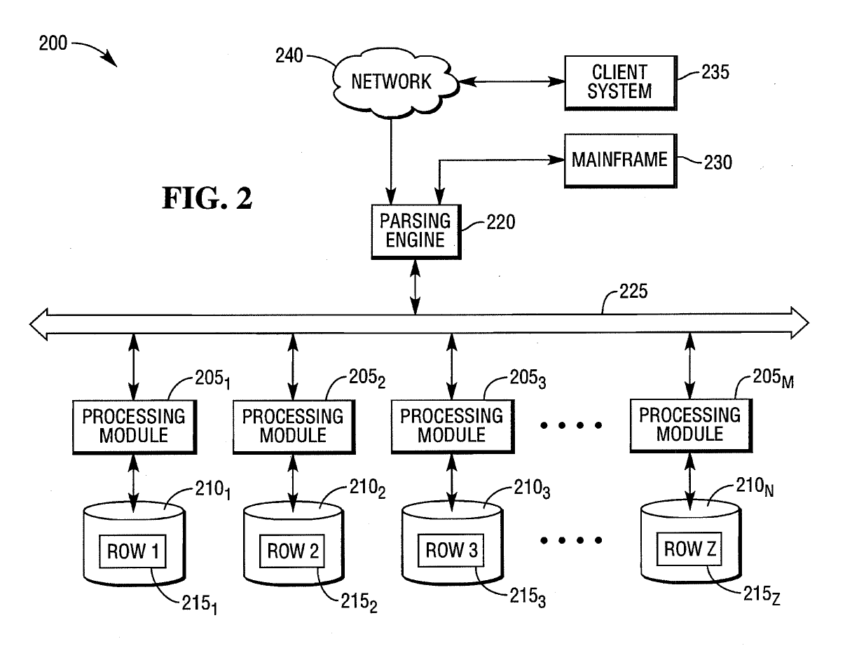

FIG. 2 shows an example of a database system 200, such as a Teradata active data warehousing system available from Teradata Corporation. Database system 200 is an example of one type of computer system in which the SQL queries are evaluated against database system 200. In the computer system 200, vast amounts of data are stored on many disk-storage facilities that are managed by many processing units. In this example the data warehouse 200 includes a relational database management system (RDMS) built upon a massively parallel processing (MPP) platform.

Other types of database systems, such as object-relational database management systems (ORDMS) or those built on symmetric multi-processing (SMP) platforms, are also suited for use here.

The database system 200 includes one or more processing modules 205_{1 . . . M} that manage the storage and retrieval of data in data storage facilities 210_{1 . . . N}. Each of the data storage facilities 210_{1 . . . N} includes one or more disk drives.

The system stores data in one or more tables in the data storage facilities 210_{1 . . . N}. The rows 215_{1 . . . Z} of the tables are stored across multiple data storage facilities 210_{1 . . . N} to ensure that the system workload is distributed evenly across the processing modules 205_{1 . . . M}. A parsing engine 220 also coordinates the retrieval of data from the data storage facilities 210_{1 . . . N} over network 225 in response to queries received from a user at a mainframe 230 or a client computer 235 connected to a network 240. The database system 200 usually receives queries and commands to build tables in a standard format such as SQL.

It is particularly important to determine the cost of evaluating queries against the database. It is also important to reorder query terms where possible to reduce cost.

### Determining the Cost of Evaluating a Condition

One aspect of the invention involves determining the cost of evaluating a condition. The condition may include one or more fixed cost operators. The condition may also include one or more variable coefficients.

The cost of evaluating the condition is based on the measured CPU paths of the fixed cost operators/functions, such as ADD, GT, MOD, and data type of the operands involved in the condition. The measured cost of each operator that is supported by the execution engine for each applicable data type is encoded as cost coefficients. Examples of applicable data types include floating point comparison and integer comparison.

Not all operators have a fixed cost coefficient. Variable coefficients include operand size dependent operators and probability based operators.

Operand size dependent operators include UPPER, LOWER, SUBSTR and string comparison. The cost of these operators depend on the size of the operand(s). A suitable linear cost formula for calculating the cost is:

Cost=overhead+cost per byte*size of argument

Probability based operators include the LIKE operator and complex CASE expressions. Suitable selectivity-based cost formulas are set out below.

A suitable formula for the LIKE operator is:

LikeCost=(1−S)*LikeNoMatchCost+S*LikeMatchCost

In the above formula S is the selectivity of the LIKE condition which is the probability of the LIKE finding a match and (1−S) is the probability of a no match.

LikeNoMatchCost and LikeMatchCost are linear functions of the pattern length and the length of the searched string.

A formula for the CASE expression is:

CaseCost=CaseOvhd+sum of (CaseBranchCost₁ . . . CaseBranchCost_{N})

In the above formula, CaseBranchCostᵢ is the weighted cost of evaluating an i-th branch in the CASE expression. The weight is determined by the selectivity of the WHEN conditions.

The formula for CaseBranchCostᵢ is as follows:

$${CaseBranchCost}_{i} = ( 1 - {PrevWhenSelectivity}_{i} ) * ( cost of {WhenCondition}_{i} ) + WhenSelectivity * ( cost of {ThenClause}_{i} )$$

There is an underlying assumption to the above formula. The assumption is that every branch of a CASE expression is an independent event with equal probability of being executed. WhenSelectivity, which is the probability of the ThenClause in the i-th branch being executed, is computed as:

WhenSelectivity=(1/NumBranches)
The WhenCondition in the i-th branch is executed if all the previous branches are not satisfied, the probability of which is (1−PrevWhenSelectivityj) where

PrevWhenSelectivityᵢ=WhenSelectivity*(i−1)

The last branch in a CASE expression doesn't have a WhenConditon. The BranchCost of this branch is
WhenSelectivity*(cost of LastThenCost)

With a cost formula for every type of operator and expression, the cost of evaluating a condition is simply that of applying the appropriate cost formulas and adding them up. Since a condition can consist of any kind of expressions in the operands, a recursive function optGetBaseCost is used to perform such computation. For example, the cost of evaluating “c1+d1>10” is:

optGetBaseCost(“c1+d1”)+optGetBaseCost(“10”)+Cost of an integer comparison

where optGetBaseCost(“c1+d1”) is:
optGetBaseCost(“c1”)+optGetBaseCost(“d1”)+Cost of an integer addition
   where optGetBaseCost(“c1”), optGetBaseCost(“d1”) and optGetBaseCst(“10”) are zero since these are references to a field or a constant whose cost have been absorbed in the measured cost of the comparison operator.

### Determining the Cost of Evaluating a Set of Conditions

Another aspect of the invention involves determining the cost of evaluating a set of conditions. Two conditions within the set of conditions can be joined by a conjunctive connector such as AND. Alternatively the set of conditions can be joined by a disjunctive connector such as OR The conjunctive and disjunctive connectors can be nested at different levels.

A typical set of conditions is set out below.
(a=1 AND b=1 AND c=1) OR (a=2 AND b=2 AND c=2) OR (a=3 AND b=3 AND (c=3 OR c=4))

Level 1 is the disjunctive connector OR This connector joins the conditions:
1. (a=1 AND b=1 AND c=1)
2. (a=2 AND b=2 AND c=2)
3. (a=3 AND b=3 AND (c=3 OR c=4))

Level 2 involves the conjunctive connector AND. This connector joins conditions within each of conditions 1-3 above:
1.1 a=1
1.2 b=1
1.3 c=1
2.1 a=2
2.2 b=2
2.3 c=2
3.1 a=3
3.2 b=3
3.3 (c=3 OR c=4)

Level 3 involves the disjunctive connector OR This connector joins the conditions within condition 3.3 above as follows:
3.3.1c=3
3.3.2c=4

The cost of evaluating the set of conditions is preferably determined recursively. Each level of the condition tree is costed in a bottom-up fashion. In other words, the cost of the lowest level of conditions is computed first. This cost is used in the costing of the next highest level of conditions. The cost of the top-most level is the cost of the entire set of conditions.

The cost of a set of conditions at a given level of a condition tree is computed based on the selectivity and cost of individual terms. The cost of a level of conditions joined by conjunctive connectors is calculated as a product of the cost of the current condition and the combined selectivity of those previous conditions joined by conjunctive connectors.

One example is a set of conditions joined by ANDs. One method of determining the cost of evaluating an i^{th} term within the set is (Sᵢ₋₁*C₁) where Sᵢ₋₁ is the combined selectivity of the previous AND'ed terms and C₁ is the cost of the current term. For the first AND'ed term, S₀ is 1 since the first term must be evaluated for every row. If the current term has only one condition, C₁ is the cost of evaluating the single condition. If the current term is a set of lower level of AND'ed or OR'ed conditions, then its cost has already been computed.

The cost of a level of conditions joined by disjunctive connectors is calculated as a product of the cost of the current condition and a function of the combined selectivity of those previous conditions joined by disjunctive connectors.

One example is a set of conditions joined by ORs. One method of determining the cost of evaluating an i^{th} term within the set is ((1−Sᵢ₋₁)*C₁) where Sᵢ₋₁ is the combined selectivity of the previous OR'ed terms and C₁ is the cost of the current term. For the first OR'ed term, S₀ is 0, i.e., ((1−S₀)=1, which means the first term is evaluated for every row.

The total cost of a set of AND'ed or OR'ed conditions is the sum of the cost of every term This cost is dependent on the order of the conditions. For example, the cost of evaluating “a=1 AND b=1 AND c=1” is smaller than the cost of evaluating “c=1 AND b=1 AND a=1” if the selectivity of “c=1” is significantly less than the selectivity of “a=1”. The reasoning is that by evaluating the condition that is least likely to be satisfied first, the probability of having to evaluate the remaining conditions decreases and therefore the total cost is lower.

Determining Optimal Order

Another aspect of the invention involves determining an optimal order of conditions within a set of conditions. As part of the costing of a set of conditions, the order of evaluating the conditions is also optimized. This is done by sorting the conditions into the order that has the smallest total cost as follows.

The cost of one or more of the conditions is/are determined within the set of conditions. Preferably the cost of each condition within the set of conditions is determined as described above.

The selectivity of one or more of the conditions is/are determined within the set of conditions. Preferably the selectivity of each condition within the set of conditions is determined as described above.

The optimal order of at least some of the conditions is then determined based at least partly on the determined cost and determined selectivity of one or more of the conditions.

When every term has the same base cost, the optimal order can be found by simply sorting the terms based on selectivity. For AND'ed terms, the terms are sorted in ascending order of the terms' reliable selectivities. For OR'ed terms, the terms are ordered in descending order of the terms' reliable selectivities. Terms that have no confidence in their selectivities, also referred to as not having reliable selectivities, are ordered after the terms with reliable selectivities.

For example, for a compound condition “a1>1 and b1=10”, assume a1 and b1 are both integer columns and therefore both simple conditions have the same base cost of C. Further assume that “b1=10” has a selectivity of 0.1 and “a1>1” has a selectivity of 0.7. The optimal order of evaluating the compound condition is “b1=10 and a1>1” with a total cost of 1.1C as opposed to the total cost of 1.7C for the order of “a1>1 and b1=10”.

When every term has the same selectivity, the optimal order can be found by ordering the terms in ascending order of their base cost. By evaluating the less costly terms first, the probability of having to evaluate the more costly terms is reduced. This applies to both AND'ed terms and OR'ed terms.

When terms have mixed selectivity and base cost, a different approach is proposed. Certain pairs of conditions joined by respective connectors are identified within the set of conditions. The cost of those identified pairs of conditions is determined. The terms are then sorted at least partly on the determined cost of the identified pairs.

One example is a 1-lookahead search strategy. The strategy is used to find the optimal order by traversing the list of terms iteratively to find and identify the next best term. In each traversal, a 1-lookahead is done to determine the next best term. For example, consider the following compound condition and assume that each individual condition has a different base cost and selectivity
a1>0 AND b1=10.3 AND c1=1

There are three conditions within this set of conditions. Let C1 be “a1>0”, C2 be “b1=10.3” and C3 be “c1=1”.

In the first round, the cost of (C1 AND C2), (C1 AND C3), (C2 AND C1), (C2 AND C3), (C3 AND C1) and (C3 AND C2) are compared and the first condition from the pair with the best cost is picked as the next best term.

Let's say C2 is selected as the first term. This leaves C1 and C3 to be considered in the second round. In this round, the cost of (C1, C3) and (C3, C1) are compared. Since this is the last round, after the first condition of the pair with the best cost is picked, the remaining condition is the last condition to evaluate. Let's say the pair (C3 AND C1) has the best cost in the last round. The optimal evaluation order is (C2 AND C3 AND C1).

Determining Cost Based on Access Method

A further aspect of the invention provides different methods of determining the cost of evaluating a condition depending on the intended access method. The three types of access envisaged include:
1. Sequential access
2. Index access using a key or a set of keys
3. RowID access using a rowID spool

Sequential Access

Sequential access is used for single-table retrieval as well as for joins that access rows in an input relation sequentially. The input relation includes a base table or an index structure. The cost in this case of sequential access is the cost of evaluating an entire set of single-table conditions for every row in the table.

Cost=TableCardinality*Cost of single-table conditions

Index Access

Index access involves searching for rows of a given key value (single-valued key access) or a set of key values (multi-valued key access) from an index.

For the single-valued version, the index is searched using a key constructed from a corresponding condition. If the key condition is the only selection condition, then there is no additional cost for condition evaluation. Additional cost for evaluating conditions is only incurred when there is a residual condition to be evaluated on the rows found from the index lookup.

An example is a table t1 with an index on b1 and a query:
sel*from t1 where b1=1 and c1>10

The condition “b1=1” is used to construct a key for accessing the index so only a cost of evaluating the residual condition “c1>10” on the “b1=1” rows is needed.

The multi-valued version of index access models the operation of probing rows in one of the join relations using rowhashes from the other join relation. It is used for the costing of hash-based joins. Hash-based joins include merge joins, nested joins and direct hash joins. In this case, an entire set of single-table conditions is evaluated on every row with the matching rowhashes.

An example is a table t1 with primary index al and a query:
sel*from t,t2 where t1.a1=t2.b2 and b1 between 10 and 20

The condition “b1 between 10 and 20” is evaluated on every t1 row accessed by the rowhashes corresponding to the values in t2.b2.

The formula for single-valued index access is:

Cost=RowsPerValue*Cost of residual conditions

The formula for multi-valued index access is:

Cost=# Values*RPV*Cost of single-table conditions

Row ID Access

Row ID list access is used for single-table retrieval using a rowID spool.

An example index on t1.b1 and an example query is:
sel*from t1 where t1.b1 between 10 and 20 and c1>10

The index t1.b1 is used to produce the rowIDs that qualify the condition “t1.b1 between 10 and 20”. In this case, the determined cost of evaluating the residual condition “c1>10” on every qualified rowId is:

Cost=# RowIds*Cost of residual conditions

The invention provides techniques for determining the cost of evaluating a condition and a set of conditions. Also described above are techniques for determining an optimal order of conditions within a set of conditions and differing cost computations based on different access methods.

These techniques have the potential to increase the accuracy of cost estimation.

They permit the optimizer to pick a more optimal access method or join method for queries with very complex conditions for which the CPU time of evaluating conditions is a significant portion of the total cost.

Optimization of the conditions ordering has the potential to yield CPU saving in query execution.

The techniques above address the costing of single-table selection conditions. It is envisaged that the same framework can be extended to cost the evaluation of join conditions. Costing of join conditions can further improve the accuracy of join costing and order of joins.

The text above describes one or more specific embodiments of a broader invention. The invention also is carried out in a variety of alternative embodiments and thus is not limited to those described here. Those other embodiments are also within the scope of the following claims.

1. A method of determining the cost of evaluating a condition, the method comprising:
determining the cost of one or more fixed cost operators within the condition; and
determining the cost of one or more variable coefficients within the condition.

2. The method of claim 1 wherein the one or more variable coefficients include one or more operand size dependent operators, the method including determining the cost of the operand size dependent operator(s) using a linear cost formula

3. The method of claim 1 wherein the one or more variable coefficients include one or more probability based operators, the method including determining the cost of the probability based operator(s) based at least partly on the selectivity of the probability based operator(s).

4. A method of determining the cost of evaluating a set of conditions, the method comprising:
determining the cost of successive conditions within the set of conditions as a function of the cost of the current condition and the combined selectivity of previous conditions within the set of conditions.

5. The method of claim 4 where two or more of the conditions within the set of conditions are joined by respective conjunctive connectors.

6. The method of claim 5 comprising determining the cost of the respective conditions as a product of the cost of the current condition and the combined selectivity of those previous conditions joined by conjunctive connectors.

7. The method of claim 4 where two or more of the conditions within the set of conditions are joined by respective disjunctive connectors.

8. The method of claim 7 comprising determining the cost of the respective conditions as a product of the cost of the current condition and a function of the combined selectivity of those previous conditions joined by disjunctive connectors.

9. A method of determining an optimal order of conditions within a set of conditions, the method comprising:
determining the cost of one or more conditions within the set of conditions;
determining the selectivity of one or more conditions within the set of conditions; and
determining an optimal order of at least some of the conditions based at least partly on the determined cost and determined selectivity of one or more of the conditions.

10. The method of claim 9 further comprising:
identifying, within the set of conditions, two or more conditions that have the same cost and are joined by respective conjunctive connectors; and
sorting the identified conditions that have reliable selectivity within the set of conditions in ascending order of selectivity of the identified conditions.

11. The method of claim 10 further comprising ordering within the set of conditions the identified conditions that do not have reliable selectivity after the identified conditions that do have associated selectivity.

12. The method of claim 9 further comprising:
identifying, within the set of conditions, two or more conditions that have the same cost and are joined by respective disjunctive connectors; and
sorting the identified conditions in descending order of selectivity of the identified conditions.

13. The method of claim 12 further comprising ordering within the set of conditions the identified conditions that do not have reliable selectivity after the identified conditions that do have reliable selectivity.

14. The method of claim 9 further comprising:
sorting the identified conditions that have the same selectivity within the set of conditions in ascending order of cost of the identified conditions.

15. The method of claim 9 further comprising:
identifying, within the set of conditions, a plurality of pairs of conditions that are joined by respective connectors;
determining the cost of one or more of the identified pairs; and
sorting the identified conditions within the set of conditions at least partly on the determined cost of the one or more of the identified pairs.

16. The method of claim 1 further comprising:
determining the cardinality of a table to be accessed sequentially, and
determining the cost of evaluating the condition at least partly from the determined table cardinality and the cost of evaluating the condition.

17. The method of claim 1 further comprising:
determining the cost of evaluating any residual conditions to be evaluated on a table to be accessed using single-valued key access; and
determining the cost of evaluating the condition at least partly from the rows per value and the determined cost of evaluating the residual conditions.

18. The method of claim 1 further comprising:
determining the cost of evaluating the condition on a table to be accessed using multi-valued key access; and
determining the cost of evaluating the condition at least partly from the number of values, the rows per value, and the cost of single table conditions.

19. The method of claim 1 further comprising:
determining the number of row identifiers involved in evaluating the condition on a table to be accessed using row ID access; and
determining the cost of evaluating the condition at least partly from the determined number of row identifiers and the cost of residual conditions.

20. A system for determining the cost of evaluating a condition, where the system is configured to:
receive a condition;
determine the cost of one or more fixed cost operators within the condition; and
determine the cost of one or more variable coefficients within the condition.

21. A system for determining the cost of evaluating a set of conditions, where the system is configured to determine the cost of successive conditions within the set of conditions as a function of the cost of the current condition and the combined selectivity of previous conditions within the set of conditions.

22. A system for determining an optimal order of conditions within a set of conditions, where the system is configured to:
determine the cost of one or more conditions within the set of conditions;
determine the selectivity of one or more conditions within the set of conditions; and
determine an optimal order of at least some of the conditions based at least partly on the determined cost and determined selectivity of one or more of the conditions.
